(19) United States
(12) Patent Application Publication
(10) Pub. No.: US 2025/0345986 A1
(43) Pub. Date: Nov. 13, 2025

(54) Additive Manufacturing Method And Additive Manufacturing Machine Implementing The Method

(71) Applicant: Lines Manufacturing S.A.S, Heiligenstein (FR)

(72) Inventors: Emerik POURSILLIE, Strasbourg (FR); Niels PERNOUX, Strasbourg (FR); Rauf GARIP, Strasbourg (FR)

(73) Assignee: Lines Manufacturing S.A.S, Heiligenstein (FR)

(21) Appl. No.: 18/270,377

(22) PCT Filed: Feb. 10, 2022
(86) PCT No.: PCT/EP2022/053222

§ 371 Date: Jan. 17, 2024

(30) Foreign Application Priority Data
Feb. 12, 2021 (FR) FR2101385

(51) Int. Cl. B29C 64/118; B29C 64/209; B29C 64/314; B29C 64/321; B33Y 10/00; B33Y 30/00; B33Y 40/10

(52) U.S. Cl. CPC B29C 64/118; B29C 64/209; B29C 64/314; B29C 64/321; B33Y 10/00; B33Y 30/00; B33Y 40/10

(57) ABSTRACT

An additive manufacturing machine for depositing molten wire in successive layers on a printing support in a manufacturing chamber to manufacture a three-dimensional part, includes: a feed unit for a raw material, a processing unit arranged to change the state of the raw material into molten material, the processing unit being fixed, located outside the manufacturing chamber and including at least one screw extruder, a flexible heating tube designed to convey molten material at its processing temperature and viscosity from the fixed processing unit to a mobile deposition unit, a mobile deposition unit located in the manufacturing chamber and including at least one deposition nozzle designed to deposit the molten material in the form of a molten wire in successive layers on the printing support and along a predetermined trajectory until the part to be manufactured is obtained.

### TECHNICAL AREA

This invention relates to a method and a machine for additive manufacturing by depositing molten wire in successive layers on a printing support in a manufacturing chamber to manufacture a three-dimensional part.

### PRIOR ART

The advantages of additive manufacturing technologies, also called 3D printing, are numerous. They make it possible to manufacture highly complex parts, inaccessible to standard manufacturing methods such as material removal (machining, cutting, etc.) or forming (molding, bending, thermoforming, etc.), at no extra cost. Overall, and regardless of the geometry of the part to be produced, production costs are very low, as no expensive tooling is required. This also facilitates all phases of design, development and industrialization. Parts can be modified indefinitely without impacting production times or costs. In particular, these technologies may be used very early on in the design process. Finally, they may process a wide variety of materials, from polymers to metals and ceramics.

In companies, these technologies enable us to rethink the entire value chain, from engineering to production. A new phase has appeared in the history of international product development and sourcing strategy. Today's industry is moving away from mass production and towards product customization and production flexibility, with a marked increase in the need for small and medium production runs. This explains the high expectations that manufacturers have of 3D printing. In fact, the additive manufacturing market is one of the most promising for years to come.

Despite a significant number of advantages, additive manufacturing technologies remain limited in terms of application. Historically used for prototyping purposes, they are still not competitive in production with respect to standard manufacturing methods for large and/or mass-produced parts. Indeed, current technologies lack productivity above all: manufacturing times are too long, and the resulting parts require time-consuming post-processing for reworking and/or adjustment. What's more, the precision of the resulting parts is relatively low, and no fine tolerances can be contemplated directly. Ultimately, these technologies can only be used to manufacture small parts in pre-production or very short production runs. To manufacture large parts, defined by a significant volume of material, e.g., greater than or equal to 1 m₃, it is generally necessary to allow a minimum of at least ten hours of manufacturing time. A number of solutions are currently being developed, but always involve a compromise between manufacturing time on the one hand, and quality and precision on the other. In short, improvement in one of the two parameters is systematically to the detriment of the other.

Among the technologies available, additive manufacturing by wire deposition, known by the acronyms DFF (Dépôt Fil Fondu [Molten Wire Deposit]), FFF (Fused Filament Fabrication), FDM (Fused Deposition Modeling), and FGF (Fused Granulated Fabrication or Fusion Granular Fabrication), is the dominant technology in terms of market share, and is set to maintain its leading position over the next few years, with marked growth potential. Currently, three technologies are available:
Large-format additive manufacturing by wire deposition from coil filament;
Large-format additive manufacturing using granular wire deposition;
Large-format additive manufacturing using concentrated energy deposition.

Wire deposition technologies feature some of the lowest induced production costs on the market. However, they are rarely or never used in production, mainly because of their mediocre performance, due to long printing times. What's more, they are unable to produce large parts at high speeds, while guaranteeing the required manufacturing tolerances. Wire deposition technologies are generally limited to a throughput of 0.3 kg/h. High speed can mean high flow rates, i.e., flow rates in excess of 20 kg/h. Depositing head speeds are said to be fast when they exceed 300 mm/s, for example. That's why available technologies don't allow manufacturers to consider them in production. They are still of interest for R&D, prototyping, and research purposes, but do not make competitive mass production possible compared with standard methods.

Some examples of wire deposition technologies are described in publications CN 108 357 091 A, CN 111 633 978 A, CN 110 253 882 B, EP 3 626 439 A1. However, none of these solutions offers the expected compromise making it possible to drastically increase the execution performance in terms of speed and precision of an additive manufacturing method making it possible to compete with conventional industrial methods. The main reasons are related to the inertia of the material processing unit when it is on board with the deposition unit, or to the lack of control over the rheology of the molten material throughout its transfer to the deposition unit when the processing unit is remote from the deposition unit.

### DISCLOSURE OF THE INVENTION

This invention aims to fill this gap by proposing a new concept of additive manufacturing by deposition of molten wire from granules, aimed at radically increasing its execution performance, so that it can position itself as an alternative to the methods of efficient, cost-effective, flexible, responsive, reproducible, and competitive standard manufacturing to produce large parts and/or mass-produced parts in an industrial environment, while guaranteeing compliance with the manufacturing tolerances required in order to minimize the rework operation when it becomes necessary.

To this end, the invention relates to a method of the kind indicated in the preamble, comprising the following steps:
a step of feeding at least one raw material,
a step of transforming the raw material into molten material in a fixed transformation unit located outside of said manufacturing chamber,
a step of conveying the molten material at its transformation temperature and viscosity in a flexible and heating tube from said fixed transformation unit to a mobile deposition unit located in said manufacturing chamber, and
a step of depositing said molten material in the form of a molten wire in successive layers on said printing support by said mobile deposition unit until the part to be manufactured is obtained.

Thanks to this particular configuration of the invention, the speed of movement of the deposition unit and its movements in space can be much more fluid, responsive, ample, and rapid, since they are totally independent of the inertia and bulk of the processing unit. In fact, the processing unit is no longer mounted on the deposition unit as in the prior art, but is offset outside the manufacturing chamber and connected to the deposition unit by a flexible heating tube, which can follow the spatial movements of the deposition unit without inertia or constraint.

What's more, the rheology of the molten material is perfectly controlled throughout its transfer from the remote processing unit to the deposition unit, irrespective of the heating temperature in the processing unit, transfer conditions (variations in flow rate, hence residence time in the tube, and variable cooling), and heat losses to the outside environment (as a function of ambient temperature, atmospheric pressure, air flows in the manufacturing site, etc.). Indeed, the molten material conveyance tube is no longer simply thermally insulated as in the prior art but heated by energy input via a heating system. In the configuration of the invention, and in the absence of a system for heating the conveying tube, the material in transit would solidify in the tube and form a plug that would be impossible to remove, thus permanently sealing the tube and making additive manufacturing by molten wire deposition impossible.

In a preferred form of the invention, said depositing step consists of modifying the molten wire cross-section during the manufacture of said part, and automatically and instantaneously adapting the printing rate to the required printing precision as a function of the manufactured parts of said part.

Thus, it is possible to reach an entirely innovative compromise between printing speed and printing quality making it possible to achieve equivalent or at least comparable performance with conventional industrial manufacturing methods.

In particular, said depositing step may consist of selecting a large section of molten wire deposited with a high printing rate and low printing precision to fill the core of said part to be manufactured, and selecting a small section of molten wire deposited with a low printing rate and high printing precision to form contours of said part to be manufactured.

In addition, said depositing step may consist of changing the raw material and/or molten wire geometry during the manufacture of said part, to automatically and instantaneously adapt the raw material and/or molten wire geometry to the manufactured parts of said part.

Preferably, said depositing step is sequenced to effect changes in cross-section and/or raw material and/or molten wire geometry according to the manufactured parts of said part.

Also for this purpose, the invention relates to a machine of the kind indicated in the preamble, comprising:
a raw material feed unit,
a processing unit designed for changing the state of the raw material into molten material, said processing unit being fixed and located outside said manufacturing chamber,
a flexible, heatable tube designed for conveying molten material at its processing temperature and viscosity from said fixed processing unit to a mobile deposition unit,
a mobile deposition unit located in said manufacturing chamber and comprising at least one deposition nozzle designed to deposit said molten material in the form of a molten wire in successive layers on said printing support and according to a predetermined trajectory until obtaining the part to be manufactured.

In a preferred form of the invention, said transformation unit comprises at least one screw extruder.

In addition, said machine may comprise a regulating device located downstream of said processing unit, between said processing unit and said flexible heating tube or preferably between said flexible heating tube and said deposition unit, and designed to regulate the flow rate and pressure of said molten material at the outlet of the processing unit or preferably at the inlet of the deposition unit. Said flexible heating tube may be coupled to at least one electrical resistor, located around the tube, and designed to reach and stabilize a setpoint temperature adapted to the molten material being conveyed, without this example being limiting.

In a preferred embodiment of the invention, said deposition unit comprises a hot block provided with an inlet port connected to said flexible heating tube or to the regulating device, and a rotary disk comprising at least two depositing nozzles at different cross-sections, angularly offset. In this case, said rotating disk is positioned downstream of said hot block and is designed to sequentially align an active depositing nozzle with an outlet port of said hot block and to allow the exit of the molten wire.

Advantageously, said deposition unit may be vertically inclined to present the active depositing nozzle as close as possible to the print substrate or the part to be manufactured, and to clear the other depositing nozzle(s) which are on standby.

Said depositing nozzles may be positioned on said rotary disc so that, in the working position, the axis of the active depositing nozzle is preferably aligned with a vertical line.

In the preferred embodiment, said hot block and said rotary disk may be coupled by a pressurized surface contact, and said rotary disk may advantageously form a switch to sequentially open the hot block when a depositing nozzle is aligned with its outlet port and close the hot block when its outlet port is located between two depositing nozzles.

Said hot block may be mounted on a fixed support block, and may be secured by means of return members in the direction of said rotary disk, allowing angular displacement of said rotary disk with respect to said hot block during a sequential changeover of the active depositing nozzle.

Depending on the variant and the part to be manufactured, said at least two rotary disk deposition nozzles may be fed with different raw materials. In this case, at least said feed unit, said processing unit, and said flexible heating tube are duplicated to feed said deposition unit with said different raw materials.

In addition, said hot block may comprise an internal shutter designed to sequentially open and close said outlet port.

### BRIEF DESCRIPTION OF THE DRAWINGS

The present invention and its advantages will become clearer in the following description of several embodiments given as non-limiting examples, with reference to the attached drawings, in which:

FIG. 1 is a schematic diagram of the manufacturing method according to the invention,

FIG. 2 is a simplified perspective view of a manufacturing machine according to the invention,

FIG. 3 is an exploded view of a deposition unit from the manufacturing machine shown in FIG. 2,

FIG. 4 is a top view of the deposition unit shown in FIG. 3,

FIG. 5 is an axial cross-sectional view of the deposition unit of FIG. 4 along cross-sectional plane V-V,

FIG. 6 is an enlarged view of detail VI of the deposition unit shown in FIG. 5,

FIG. 7 is an axial cross-section of a material nozzle belonging to the deposition unit shown in FIG. 3,

FIG. 8 is an axial cross-section of a hot block of the deposition unit equipped with a shutter in closed position,

FIG. 9 is a view equivalent to FIG. 8, showing the shutter in the open position,

FIG. 10 is a perspective view of a part manufactured using the method and additive manufacturing machine of the invention, showing its constituent parts, and

FIG. 11 is a cross-sectional view of the part shown in FIG. 10, showing its various constituent parts.

### DESCRIPTION OF EMBODIMENTS

In the illustrated examples, identical elements or parts have the same reference numbers. Furthermore, terms having a relative meaning, such as vertical, horizontal, right, left, front, rear, above, below, etc., are to be interpreted under normal conditions of use of the invention, and as represented on the figures.

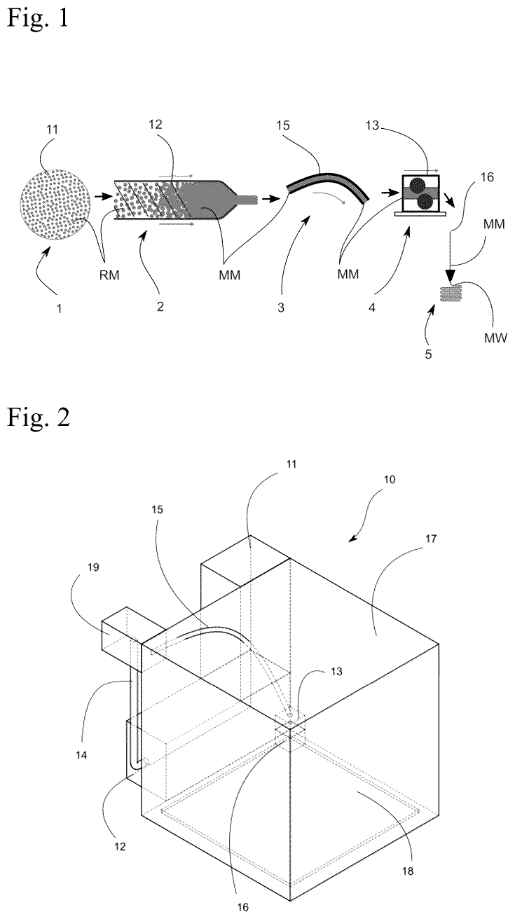

With reference to the diagram shown in FIG. 1, the manufacturing method according to the invention comprises the following steps:
Step 1: feeding a solid raw material RM,
Step 2: processing of solid raw material RM into molten material MM,
Step 3: conveyance of the molten material MM,
Step 4: regulation of the flow rate of the molten material MM, and
Step 5: depositing molten material MM in the form of a molten wire MW in successive layers along a parameterized trajectory to manufacture a three-dimensional part.

Steps 3 and 4 may also be reversed as needed.

In step 1, the manufacturing method receives a raw material made of any type of polymer, whether composite or not, into a feed unit 11, which can be processed by lowering its viscosity following a rise in temperature. This raw material preferably consists wholly or partly of a thermoplastic polymer, and may or may not include any type of reinforcement, additives and/or adjuvants. The raw material must be such that its viscosity stabilizes at a “low” level, increasing its flow capacity, when exposed to a “processing” temperature. Conversely, as soon as the exposure temperature is lowered below the processing temperature, the viscosity of the material must return to a so-called “high” level, reducing its flow capacity. This fluidizing capacity facilitates the transfer of the raw material to depositing step 5. It may take various forms, such as vitreous or solid elements like fragments, granules, flakes, pellets, chips, powder, and the like, or in paste form, or as a non-Newtonian fluid. In the case of vitreous or solid elements, the raw material preferably has a relatively homogeneous particle size suitable for processing Step 2. What's more, it's in this form that thermoplastic polymers are most widely used and exploited, at a price on average 10 times lower than its equivalent in coil-packed filament form. This raw material may be transferred from feed unit 11 to processing unit 12 by any suitable means, whether manual, semi-automatic or automatic, using standard peripherals of the plastics industry, such as dryers, hoppers, suction systems, silos, etc.

In stage 2, the processing of the raw material, known as plasticization, consists of a change of the solid particle state into a more homogeneous, uniform pasty mass. In the case of a thermoplastic polymer, an input of thermal and mechanical energy leads to a rise in temperature and thus to fluidization of the material. This plasticization is carried out using a processing unit 12, preferably a rotary screw extruder or similar plasticizing device. For extruders, any type of extruder screw geometry is suitable. Screw extrusion technology has the advantage of rapidly lowering the viscosity of the thermoplastic polymer by combining:
temperature elevation by means of heating collars and any other equivalent means of thermal energy supply,
shear between the screw threads and the extruder tube: thermoplastic extrusion polymers are rheofluidizing, i.e., their viscosity decreases if the material is sheared, and
increased pressure at the end of the screw: the profile of the screw compresses the polymer, increasing the pressure and therefore the temperature of the mixture, to melt and mix the material even more efficiently.

Virtually all the polymers used in the industry are designed to be processed using this extrusion method, which has the advantage of combining all these effects. There are no equivalent solutions other than screw extrusion that offer the same characteristics. Depending on requirements, the invention may also implement other types of processing units, such as a heated mixer or similar, even if their level of performance and/or convenience is lower.

In the case of an extruder, rotation of the extrusion screw(s) generates a displacement of the material, creating a measurable volume flow rate. The extruder must be able to deliver a stable output flow rate over time, in line with a pre-set setpoint flow rate. The use of a screw extruder is therefore the preferred choice, as it allows you to:
a fast, efficient change in the state of the polymer,
simplification of the material change process: it is sufficient to simply insert a few purge granules to expel debris from the previous material before introducing the new material. This makes screw extrusion particularly suitable for use in production, where material changes are frequent and need to be very rapid, and above all without debris from the previous material “polluting” the new material.
An optimized processing unit design 12, since a screw extruder generates output without the need for a pump upstream of the tube. In the invention, the tube is directly connected at the extrusion outlet. Processing unit 12 is therefore very compact, and simplifies multi-material printing configurations, which require one screw extruder per material.

Advantageously, processing unit 12 is positioned in a fixed manner outside manufacturing chamber 17. The extruder may therefore be used to its full capacity and does not penalize the speed of movement of deposition unit 16 in step 5, unlike the additive manufacturing machines of the prior art. Indeed, in the prior art, the extruder is positioned in the manufacturing chamber, coupled directly to the deposition unit, which means that a heavy, cumbersome assembly with very high inertia has to be moved, limiting the deposition unit's speed of movement and freedom of movement. In addition, because the extruder is fixed, it may potentially be much more massive than prior art on-board extruders, and therefore develop greater extrusion power. Locating the extruder outside the printing zone, i.e., at a distance from manufacturing chamber 17, also simplifies the design of processing unit 12 and its use in terms of maintenance, start-up, etc., by making the extruder(s) both highly accessible outside manufacturing chamber 17 and highly modular. Finally, processing unit 12 may be positioned at a distance from manufacturing chamber 17, without affecting the quality of the molten wire leaving deposition unit 16, thanks to the flexible, heated conveyance tube 15.

In step 3, the molten material is conveyed from the fixed processing unit 12 to a mobile deposition unit 16, via a flexible heating tube 15, heated to a given temperature. This flexible heating tube 15 of a defined length can be made up of several coaxial layers to ensure its various functions, such as: flow of the molten material, heating of the molten material to maintain it at a given viscosity or to make it reach a viscosity given if it is different from that at the extruder outlet, insulation of the tube vis-à-vis the external peripherals, and control of the flow and the temperature of the molten material conveyed. The structure and the constituent layers of the flexible heating tube 15 are determined according to the material to be conveyed, its corrosive or abrasive character, and its transformation temperature. For example, this flexible tube 15 is heated by electrical resistors, such as heating collars, heating cables and/or heating ribbons, placed around the tube conveying the material, thus enabling the setpoint temperature to be reached and stabilized. The use of electric heating makes it possible to simplify the design of the flexible tube 15 in terms of weight, dimensions, sealing, and insulation. Electric heating also enables better temperature control, as electric resistors are highly reactive to a change in setpoint temperature, or may be used for certain applications subject to strict health standards, such as in the medical sector. Of course, any other means of heating the flexible tube 15 may be suitable, depending on the application, such as steam, oil, induction or similar. The tube is designed to be flexible, allowing a certain amplitude of movement to carry out depositing step 5 with respect to the fixed processing unit 12, which is remote from said manufacturing chamber 17.

In step 4, and in order to better control the characteristics of the molten material flow at the inlet to deposition unit 16, a flow and pressure regulating device 13 may be provided downstream of the extruder, and preferably downstream of flexible heating tube 15. This regulating device 13 may be made necessary by the path of the molten material beyond the extruder, and in particular, through flexible heating tube 15 which conveys the molten material to stage 3. The longer the path from processing unit 12 to deposition unit 16, the greater the pressure required of the extruder. However, the stability of the extruder output rate may be degraded, particularly as a function of the rotational speed of the extruder screw(s). The regulating device 13 then provides an interface between flexible heating tube 15 and deposition unit 16, to compensate for any lack of stability in the flow rate. It may be a gear pump, also known as a polymer pump, or any other equivalent means, which regulates the flow rate of molten material leaving the extruder and ensures a controlled and constant pressure, despite any pressure variations at the extruder outlet. The efficiency of control device 13 is at its peak closest to the point where the molten material is deposited. In this way, control device 13 may be mounted on deposition unit 16.

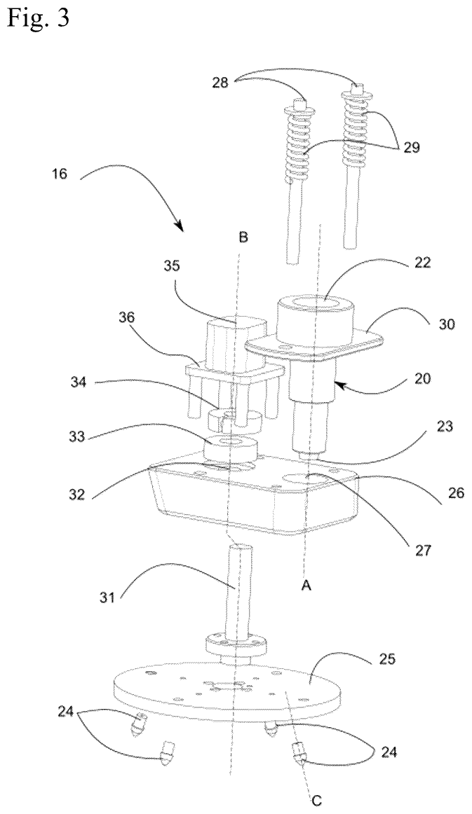

In step 5, depositing molten material in the form of molten wire requires deposition unit 16 designed to control and calibrate the exit of molten material above a print support 18 into manufacturing chamber 17. Deposition unit 16 is also heated to maintain the molten material at a given viscosity. In addition, deposition unit 16 is mobile and set in motion in manufacturing chamber 17 with respect to the print support 18 along a pre-set trajectory to manufacture a three-dimensional part layer by layer using the molten wire deposition additive manufacturing technique. Deposition unit 16 has at least one deposition nozzle 24 (FIG. 3) which determines the cross-section of the deposited molten wire in terms of transverse dimension and geometry. Deposition unit 16 may be mounted on a carriage that is spatially mobile along 3 or more axes, on a digitally controlled machine or at the end of a multi-axis robotic arm, depending on the part to be manufactured.

FIG. 2 schematically illustrates an example of a manufacturing machine 10 according to the invention. It comprises, in order, the following:
a feed unit 11 in which the solid raw material is stored, for example in the form of granules,
a processing unit 12, such as a screw extruder, fed automatically with solid raw material by feed unit 11, to transform it into molten material,
a flexible heating tube 15 connected to the outlet of the screw extruder by a conduit 14 via an adapter 19, and to the inlet of the regulating device 13 to convey the molten material into manufacturing chamber 17,
a device 13 for regulating the flow rate and the pressure of the flow of molten material, connected to the outlet of the flexible heating tube 15 and to the inlet of deposition unit 16, and
a mobile deposition unit 16 inside manufacturing chamber 17 to deposit molten material in the form of a molten wire on a printing support 18 in successive layers until a part to be manufactured is obtained.

Manufacturing machine 10 of the invention differs from the prior art in that processing unit 12 is positioned at a fixed location, outside manufacturing chamber 17 and at a distance from deposition unit 16. Thanks to this configuration, the speed of movement of deposition unit 16 is not penalized by the mass or bulk of processing unit 12, as is the case in the prior art. In addition, deposition unit 16 advantageously comprises several deposition nozzles 24 (FIG. 3) which can be replaced almost instantaneously and automatically during production. This capability enables deposition nozzle 24 to be modified, thereby adapting the printing rate and/or the molten material and/or the cross-section and/or the geometry of the deposited molten wire according to the parts of the part to be manufactured, as explained below.

In this way, manufacturing machine 10 may be fed a single raw material or a number of raw materials. In the latter case, either the system comprising feed unit 11, processing unit 12, flexible heating tube 15 and regulating device 13 is duplicated according to the number of different raw materials, and deposition unit 16 is common with multiple inlets, or the entire feed unit 11 is duplicated with deposition unit 16 to have a complete system per material, with several deposition units 16 mounted on the mobile part of the machine.

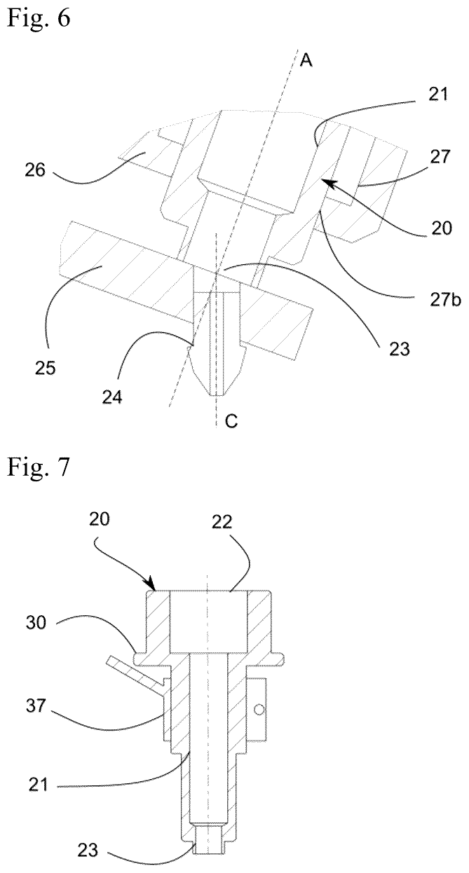

Deposition unit 16 is illustrated in greater detail in FIGS. 3 to 9. It comprises hot block 20 traversed by channel 21 extending between inlet port 22 connected to flexible heating tube 15 by a sealed connector (not shown), and an outlet port 23 communicating with a deposition nozzle 24. Deposition nozzle 24 is carried by a rotary disk 25. This rotary disk 25 comprises several deposition nozzles 24, for example, four deposition nozzles 24, this number not being limitative. Deposition nozzles 24 are angularly spaced apart, either evenly or unevenly, on a circle passing through outlet 23 of hot block 20. Deposition nozzles 24 consist of a body through which a straight duct with axis C passes. The cross-section of the duct determines the cross-section of the molten wire emerging from it. Each deposition nozzle 24 is preferably different from the other nozzles in terms of its outlet cross-section, transverse dimension and/or geometry. The geometry of the outlet section of the deposition nozzles 24 may be in the group comprising a circle, rectangle, square, oval or any other geometric shape or shape not compatible with the printing requirement. And the transverse dimension of the outlet section of deposition nozzles 24 may be defined by the diameter of a circle, the length, and width of a rectangle, the side of a square, the two transverse dimensions of an oval, or any other transverse dimension of any other geometric or non-geometric shape. In addition, deposition nozzles 24 can be made of different materials, depending on the raw material(s) RM fed to manufacturing machine 10, and their abrasive or corrosive properties.

Deposition unit 16 comprises a support block 26 carrying hot block 20 along axis A and the rotary disk 25 along axis B parallel to axis A. Hot block 20 is mounted through bore 27 in support block 26 by means of a sliding connection at the top and bottom guide zones 27a, 27b, giving a degree of freedom in axial translation to said hot block 20. In addition, hot block 20 is held in axial translation towards the rotary disk 25 by return members. In the example shown, these return elements consist of, but are not limited to, two parallel pre-tension screws 28, associated with two compression springs 29. Pre-tension screws 28 pass through flange 30 on hot block 20 and are screwed into support block 26. Compression springs 29 extend between the base of the pre-tension screw heads 28 and said flange 30. In this way, when the pre-tension screws 28 are screwed in, they compress the compression springs 29, which then generate a greater return force as they are compressed. This force is transmitted to the interface between the end of the hot block 20 and the rotary disk 25. The end of the outlet orifice 23 of the hot block 20 is therefore in permanent contact with the corresponding face of the rotary disk 25 via a pressurized surface contact. This mechanical connection by plane contact under pressure has the advantage of sealing the interface between hot block 20 and rotary disk 25 with respect to the molten material under pressure. It also has the advantage of allowing rotary disk 25 to move relative to hot block 20 only when the disk is rotating, without any additional mechanism. Rotary disk 25 then provides a simple means of switching hot block 20 automatically between a closed position, in which it is positioned between two deposition nozzles 24, and a closed position, and the corresponding solid face of the disk closes its outlet orifice 23 interrupting the deposition of molten wire, and an open position in which it is aligned with one of the deposition nozzles 24 and the active deposition nozzle 24 opens its outlet orifice 23 enabling the deposition of molten wire.

In a variant not shown, the interface between outlet orifice 23 of hot block 20 and rotary disk 25 may be sealed by a mechanical sliding connection between the two elements, resulting in permanent surface contact in the proximity of deposition nozzles 24. In this configuration, hot block 20 may be shaped to fit over the edge of the rotary disk in line with its outlet orifice 23, covering the edge of the rotary disk 25 and forming a double bearing surface with the rotary disk 25 so as to be in simultaneous contact with its upper and lower surfaces. This construction ensures controlled axial mechanical play at the interface. An alternative configuration may be provided by an enveloping shape located on rotary disk 25, containing the interface and the outlet orifice 23 of hot block 20. These different scenarios provide an advantageous sealing of the interface, containing the flow of raw material without inducing contact pressure between hot block 20 and rotary disk 25, thereby minimizing friction and limiting the risk of blockage during the rotation of disk 25.

Rotary disk 25 is secured to a transmission shaft 31 mounted for rotation about axis B in housing 32 of the support block 26 via ball bearings 33 or similar. It is locked axially by a clamping ring 34 or other locking device. Drive shaft 31 is coupled to actuator 35, such as a stepper motor, servomotor, rotary actuator or similar, to control the angular displacement of rotary disk 25 about axis B and precisely position the selected active deposition nozzle 24 opposite outlet orifice 23 of hot block 20. Actuator 35 may be attached to support block 26 by means of console 36 or other suitable means.

In a variant embodiment not shown, rotary disk 25 may be provided with a toothed ring gear, arranged in a plane normal to drive shaft 31. In this case, actuator 35 is not coupled to drive shaft 31, but is fitted with a sprocket that directly or indirectly drives the toothed ring gear, which is itself built into rotary disk 25. If the diameter of the toothed ring gear is greater than the diameter of the sprocket, this advantageously maximizes the torque transmitted, thus limiting any friction-related blockages at the interface between rotary disk 25 and hot block 20.

In another alternative embodiment, not shown, actuator 35 is anchored to deposition unit 16 and acts on rotary disk 25 at a point not coincident with the axis of rotation B of drive shaft 31, generating a torque to drive rotary disk 25 by applying a tangential force. When the distance between the point of application and the axis of rotation B is at a maximum, the torque transmitted is favorably greater, thus limiting any possible friction-related blockages at the interface between the rotary disk 25 and the hot block 20.

In the example shown in FIG. 5, deposition unit 16 is not vertical, but preferably inclined with respect to the vertical, for example by an angle of between 0 and 90°, excluding these extreme values, and preferably equal to 20° without these values being limitative. This inclination lowers the outlet level of the molten material flow from active deposition nozzle 24, which is closest to the print substrate 18 or the part being manufactured, and frees up the other stand-by or passive deposition nozzles 24 at a higher level. Of course, this example is not limitative, and any other variant of a rotary disk, articulated or not, which fulfills the same function, i.e., defining a working position for an active deposition nozzle at a lower level with respect to the stand-by positions for the other passive deposition nozzles, could be suitable. Deposition nozzles 24 are positioned on rotary disk 25 in such a way that, in the working position, the C axis of active deposition nozzle 24 is aligned with a vertical line. Thus, the molten wire emerging from the active deposition nozzle 24 is also vertical and can be deposited with precision at the desired location.

Deposition nozzles 24 are each thermoregulated by a heating element, not shown. This may be a resistive heated collar combined with a thermocouple, a cartridge heater, or any other suitable heating element. Regulation may be carried out individually for each deposition nozzle 24, or across the board with a single target temperature for all nozzles. These may reach temperatures on the order of several hundred degrees Celsius. To minimize heat exchange with other components of the deposition unit 16, the peripheral zones of deposition nozzles 24 can be recessed to further minimize heat conduction. Temperature management throughout deposition unit 16 is improved by the addition of axial fans (not shown), advantageously positioned to cool certain areas of rotary disk 25, drive shaft 31, or ball bearings 33, for example.

Hot block 20 is thermoregulated by a heated element coupled to its outer surface. This may be a resistive heated collar 37, associated with a thermocouple as shown in FIG. 7, or any other suitable heating element. Hot block 20 can reach temperatures of several hundred degrees Celsius. To minimize heat exchange with the other components of the deposition unit 16, the two guide zones 27a, 27b have small contact surfaces with hot block 20. The material recess provided in the areas peripheral to guide zones 27a, 27b, further minimizes heat conduction to other components connected to deposition unit 16.

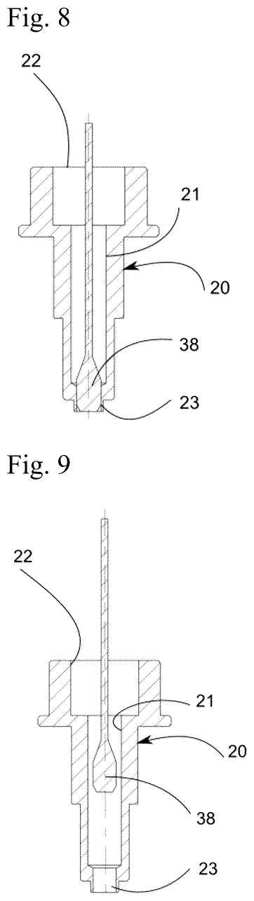

In a variant shown in FIGS. 8 and 9, hot block 20 may include a shutter 38 in its interior volume, to better control the flow of molten material. This may be a needle mounted axially in hot block 20 and controlled by a member (not shown) between a closed position shown in FIG. 8 and an open position shown in FIG. 9, depending on the manufacturing sequences.

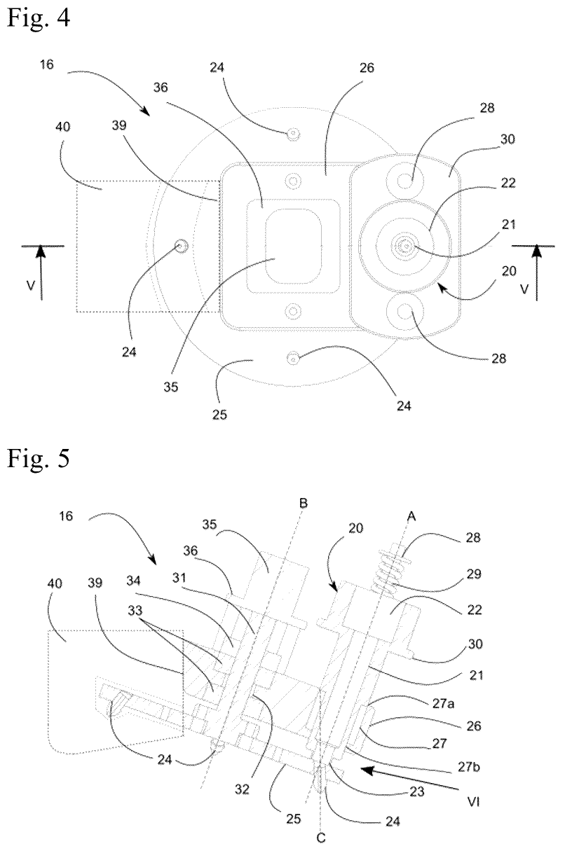

Support block 26 is the central structural component of deposition unit 16, linking all the components of deposition unit 16 together. Its side surfaces 39 enable deposition unit 16 to be coupled to an external element, for example, a mechanical actuator, such as a carriage, a digitally controlled machine, or a robot arm (not shown), enabling deposition unit 16 to be set in motion. Furthermore, an additional module 40 may be mounted directly on support block 26, as shown in FIGS. 4 and 5. In this case, it may be an additional module 40 interacting with the standby or passive deposition nozzles 24, such as a cleaning or a heating station, these examples being non-limiting.

Manufacturing machine 10 according to the invention thus enables industrial production of a part, whatever its volume and/or complexity and/or the number to be produced, by depositing material in a productive and thus competitive manner. The part to be manufactured is digitized and software defines the trajectories in space that deposition unit 16 must follow to build said part as faithfully and as qualitatively as possible. During digitization, the part to be manufactured is further broken down into different parts to be manufactured according to the degree of precision required and/or the type of material required and/or the printing pattern for each constituent part.

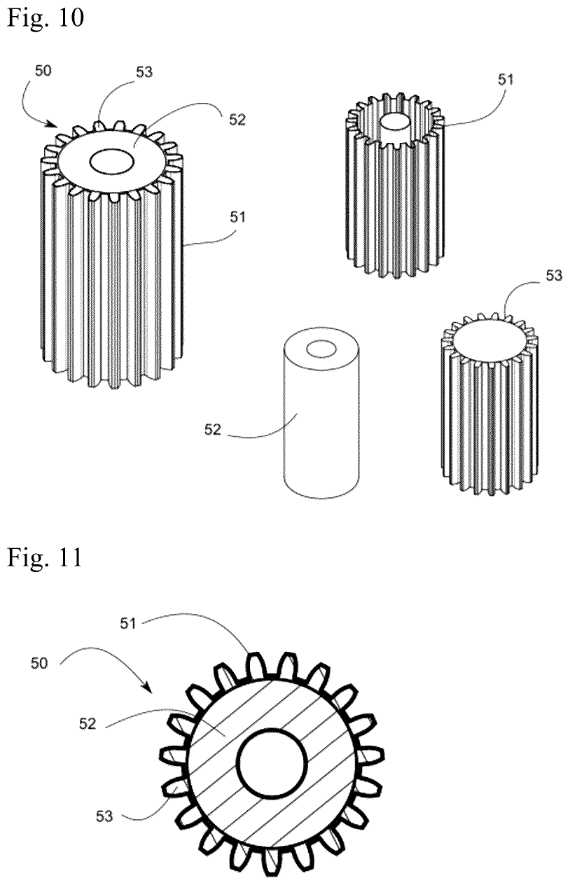

FIGS. 10 and 11 illustrate, by way of example, a gearwheel 50 to be manufactured. In this example, the gearwheel 50 may be broken down into at least three parts with different properties, such as:
an external part 51, called the shell or shroud, of low thickness, which requires both very high manufacturing precision and very high mechanical strength, as it has to perform a gearing function with another part and transmit dynamic forces without any play;
a central part 52, called the core, which gives volume to the part and requires mechanical strength but without great precision, as the central bore is intended for mounting the gearwheel on a drive shaft by keying or another mounting means; and
an intermediate part 53, located between the outer part 51 and the central part 52, of medium thickness, which requires good precision and sufficient mechanical strength to form the gearwheel teeth and support the outer part 51.

In this example, it is possible to use three deposition nozzles 24, with a circular outlet cross-section and with differing diameters, which may be fed with the same raw material, such as:
a first nozzle 24 with a very small diameter, e.g., equal to 0.4 mm, which may correspond to the thickness of the wall, combined with a low printing rate, e.g., less than or equal to 1 kg/h, to guarantee very high printing precision, e.g., a layer height (vertical precision) of around 0.1 mm, to form the outer portion 51 of the part;
a depositing nozzle 24 with an average diameter, for example equal to 1 mm, associated with an average printing rate of a few kilograms per hour, for example around 3 kg/h, for average printing precision, by example a layer height of about 0.8 mm, and form the intermediate part 53 of the part; and
a deposition nozzle 24 with a large diameter, e.g., 10 mm, combined with a very high printing rate of several tens of kilograms per hour, e.g., around 20 kg/h, for low precision, e.g., a layer height of around 5 mm, to form the central portion 52 of the part. Of course, these values are given for information only and may vary depending on processing temperatures, raw materials used, etc.

To produce this part, the machine control software will sequence the manufacturing process to automatically and instantaneously change deposition nozzle 24 according to the part to be manufactured. For this purpose, the rotary disk 25 is angularly controlled very precisely by actuator 35 to change active deposition nozzle 24, which is aligned with the outlet orifice 23 of hot block 20, which is permanently fed with molten material under pressure from processing unit 12 via the flexible heating tube 15 and regulating device 13. These changes of deposition nozzles 24 have the advantage of being carried out continuously without stopping the machine during the manufacturing process of said part.

The advantage of working with a single deposition unit 16, as opposed to a plurality of deposition units in the prior art, lies in:
the simplification and compactness of the deposition unit 16, which is able to carry at least four different deposition nozzles 24 for a single material feed,
the speed of changeover between two deposition nozzles 24, which is almost instantaneous (˜0.5 sec), a very important parameter since, for a 1 m-high part, there are at least 2,000 superimposed layers of material. So if two different deposition nozzles are used, this corresponds to a total of 4,000 changes in this example. With two separate deposition nozzles, the changeover time is several seconds (usually between 3 and 5), resulting in a dead time of between 3.3 h and 5.5 h to change the deposition nozzle for each layer. With the invention's solution, this dead time is reduced to 0.5 h,
improved repositioning accuracy between two deposition nozzles, as the machining precision in the invention is to within a hundredth of a mm (+/−0.01 mm). With two separate deposition nozzles, as in the prior art, this precision is either degraded, since typically motion solutions have a precision on the order of a tenth of a millimeter (+/−0.1 to 0.3 mm), or responsible for a significant additional cost to integrate and duplicate very precise motion solutions. This has a direct impact on the manufacturing precision of the resulting part, although the values given are for guidance only.

The gearwheel 50 is only given as an example to illustrate how it is possible to think differently about the manufacture of industrial parts by breaking them down into sub-parts, in order to optimize and make the most of the additive manufacturing method by depositing molten wire, according to the invention. In particular, this method enables us to reduce printing times by a factor of 100 with respect to the market leaders, to produce larger parts, e.g., up to 8 m³ and multi-material parts, e.g., up to 10 different polymers simultaneously, which may typically be combined from high-tech polymers to the most technically advanced polymers, making the method flexible, scalable and intelligent.

It is clear from this description that the invention achieves the stated objectives, and brings additive manufacturing technology and its benefits into industrial production processes, offering a highly flexible and competitive alternative manufacturing solution. As a result, it may be easily integrated into the industry ecosystem, particularly in terms of raw material and connector standards. All of these factors greatly facilitate the transition of 3D printing technologies from the design office to production units.

This invention is of course not limited to the embodiments described, but extends to all modifications and variants obvious to a person skilled in the art, within the limits of the appended claims. Furthermore, the technical characteristics of the various embodiments and variants mentioned above may be combined, in whole or in part, without departing from the appended claims.

1. An additive manufacturing method by deposition of a molten wire in successive layers on a printing support in a manufacturing chamber to manufacture a three-dimensional part, comprising the following steps:
a feeding step of at least one raw material,
a step of processing the raw material into a molten material in a fixed processing unit located outside said manufacturing chamber,
a step of conveying the molten material at its processing temperature and viscosity in a flexible heating tube from said fixed processing unit to a mobile deposition unit located in said manufacturing chamber, and
a step of depositing said molten material in the form of a molten wire in successive layers on said printing support by said mobile deposition unit until a part to be manufactured is obtained.

2. The method according to claim 1, in which said deposition step consists of modifying a section of the molten wire during the manufacture of said part, and automatically and instantaneously adapting a printing rate to a required printing precision as a function of the manufactured parts of said part.

3. The method according to claim 1, wherein said deposition step consists of selecting a large section of the molten wire deposited with a high printing rate and a low printing precision to fill a core of said part to be manufactured and selecting a small section of the molten wire deposited with a low printing rate and a high printing precision to form contours of said part to be manufactured.

4. The method according to a claim 1, wherein said deposition step consists of changing a molten wire raw material during the manufacture of said part, to adapt the molten wire raw material automatically and instantaneously in accordance with the manufactured parts of said part.

5. The method according to claim 1, wherein said deposition step consists of changing a molten wire geometry during the manufacture of said part, to automatically and instantaneously adapt the molten wire geometry in accordance with the manufactured parts of said part.

6. The method according to claim 1, wherein said deposition step is sequenced to effect changes in section and/or raw material and/or molten wire geometry in accordance with the manufactured parts of said part.

7. An additive manufacturing machine for depositing a molten wire in successive layers on a printing support in a manufacturing chamber to manufacture a three-dimensional part, comprising:
a feed unit for a raw material,
a processing unit designed to change a state of the raw material into a molten material, said processing unit being fixed and located outside said manufacturing chamber,
a flexible heating tube designed to convey the molten material at its processing temperature and viscosity from said fixed processing unit to a mobile deposition unit,
said mobile deposition unit located in said manufacturing chamber and comprising at least one deposition nozzle designed to deposit said molten material in the form of a molten wire in successive layers on said printing support and along a predetermined trajectory until the part to be manufactured is obtained.

8. The machine according to claim 7, characterized in that said processing unit comprises at least one screw extruder.

9. The machine according to claim 7, further comprising a regulating device located downstream of said processing unit, between said processing unit and said flexible heating tube and designed to regulate a flow rate and pressure of said molten material at an outlet of the processing unit.

10. The machine according to claim 7, characterized in that said flexible heating tube is coupled to at least one electrical resistor, positioned around the flexible heating tube, and designed to reach and stabilize a setpoint temperature adapted to the molten material being conveyed.

11. The machine according to claim 7, characterized in that said deposition unit comprises a hot block provided with an inlet orifice connected downstream of said flexible heating tube, and a rotary disk comprising at least two deposition nozzles of different cross-sections, angularly offset, and in that the rotary disk is located downstream of said hot block and designed to sequentially align an active deposition nozzle with an outlet orifice of said hot block and allow the molten wire to exit.

12. The machine according to claim 11, characterized in that said deposition unit is inclined with respect to a vertical line to bring an active deposition nozzle as close as possible to a print support or a part to be manufactured, and to clear other deposition nozzle(s) which are on standby.

13. The machine according to claim 11, characterized in that the deposition nozzles are positioned on said rotary disk so that, in a working position, an axis of an active deposition nozzle is aligned with a vertical line.

14. The machine according to a claim 11, characterized in that said hot block and said rotary disk are coupled by surface contact under pressure, and in that said rotary disk forms a switch for sequentially opening the hot block when one of said deposition nozzles is aligned with its outlet orifice and closing the hot block when its outlet orifice is located between two deposition nozzles.

15. The machine according to claim 11, characterized in that said hot block is mounted in a fixed support block, and is secured by return members in a direction of said rotary disk allowing angular displacement of said rotary disk with respect to said hot block during a sequential changeover of an active deposition nozzle.

16. The machine according to claim 11, characterized in that said at least two deposition nozzles of the rotary disk are fed with different raw materials, and in that at least said feed unit, said processing unit, and said flexible heating tube are duplicated to feed said deposition unit with said different raw materials.

17. The machine according to say claim 11, characterized in that said hot block comprises an internal shutter designed to sequentially open and close said outlet orifice.

18. The machine according to claim 7 further comprising a regulating device located downstream of said processing unit, between said flexible heating tube and said deposition unit, and designed to regulate a flow rate and pressure of said molten material at an inlet of the deposition unit.
